(19) United States
(12) Patent Application Publication
(10) Pub. No.: US 2023/0311121 A1
(43) Pub. Date: Oct. 5, 2023

(54) METHOD AND SYSTEM FOR STUDYING OBJECTS, IN PARTICULAR BIOLOGICAL CELLS

(71) Applicant: LUMICKS CA HOLDING B.V., Amsterdam (NL)

(72) Inventors: Felix Oswald, Amsterdam (NL); Douwe Kamsma, Amsterdam (NL); Gerrit Sitters, Amsterdam (NL)

(21) Appl. No.: 18/023,287

(22) PCT Filed: Aug. 31, 2021
(86) PCT No.: PCT/NL2021/050528

§ 371 Date: Feb. 24, 2023

(30) Foreign Application Priority Data
Aug. 31, 2020 (NL) 2026383

(51) Int. Cl. B01L 3/00

(52) U.S. Cl. CPC B01L 3/50273; B01L 2400/0436; B01L 2200/0647

(57) ABSTRACT

Systems and methods for manipulating and/or investigating objects, in particular biological objects such as cellular bodies, in a sample holder are provided. The sample holder comprises a holding space for holding a sample comprising one or more objects in a fluid medium. An acoustic wave generator is connected with the sample holder to generate an acoustic wave in the holding space exerting a force on at least part of the sample. Fluid flows through microfluidic channels in the sample holder and acoustic waves are controlled.

### CROSS-REFERENCE TO RELATED APPLICATION(S)

This application is a Section 371 National Stage Application of International Application No. PCT/NL2021/050528, filed Aug. 31, 2021, and published as WO 2022/045892 A1 on Mar. 3, 2022, and further claims priority to Netherlands Patent Application No. 2026383, filed Aug. 31, 2020.

### TECHNICAL FIELD

The present disclosure relates to methods and systems for studying microscopic objects, in particular biological objects like cellular bodies.

### BACKGROUND

Studying biological cellular bodies is well known. E.g. WO 20141200341 discloses a molecular manipulation system for investigating molecules, having a sample holder constructed to hold a sample comprising a plurality of molecules attached on one side to a surface in the sample holder and on another side attached to a microbead of a plurality of microbeads. The system having; an acoustic wave generator to generate an acoustic wave exerting a force on the microbeads in the sample; and a detector device to detect a response of the plurality of microbeads in the sample on the force exerted by the acoustic wave to investigate the molecules attached to the microbeads. This system can also be used to cellular bodies in order to study biological and molecular binding forces.

WO 2018/083193 discloses a method of manipulating and/or investigating cellular bodies. The method comprises the steps of: providing a sample holder comprising a holding space for holding a fluid medium; providing a sample comprising one or more cellular bodies in a fluid medium in the holding space; generating an acoustic wave in the holding space exerting a force on the sample in the holding space. The method further comprises providing the holding space with a functionalised wall surface portion to be contacted by the sample and the sample is in contact with the functionalised wall surface portion during at least part of the step of application of the acoustic wave. A system and a sample holder are also provided.

The technologies disclosed in these applications are very valuable for detecting biological processes.

However, improvements, in particular improvements in speed and precision of detection of particular cellular bodies and/or interactions of cellular bodies and the functionalized wall surface and improvements in reduction of required sample material are still desired. Further improvements still desired are improvements in the precise control over the forces applied to the cellular bodies and in the accuracy with which cellular bodies can be separated according to binding force.

It is further noted that other techniques have been described as well: US 2002/0076825 discloses an integrated system for sample preparation and analysis; US 2007/0184433 discloses microparticle chip systems and uses thereof; US 2011/0207238 discloses a biological substance analysing method, and a biological substance analysing cell, a biological substance analysing chip, and a biological substance analysing apparatus employed in the biological substance analysing method; U.S. Pat. No. 7,081,192 discloses methods for manipulating moieties in microfluidic systems; US 2017/0299492 discloses a method, device and system for hydrodynamic flow focusing; ON 110343603 discloses a microfluidic chip for preventing cell occlusion by using sheath fluid countercurrent; US 2018/0257076 discloses acoustic wave sorting using surface acoustic waves; and WO 2005/107939 discloses equipment using piezoelectric devices wherein complicated operation or process are performed by generating acoustic waves or oscillations by a piezoelectric device.

However, further improvements are still sought after.

### SUMMARY

In view of the above, herewith a method of manipulating and/or investigating cellular bodies is provided. Further, a manipulation system for investigating biological cellular bodies is provided. Various aspects and embodiments of both are discussed below.

A method of manipulating and/or investigating objects is provided, comprising: providing a sample holder comprising a holding space for holding a fluid medium; providing a sample comprising one or more objects in a fluid medium in the holding space; and generating an acoustic wave in the holding space exerting a force on the one or more objects of the sample in the holding space.

The method further comprises providing a sample fluid flow through the holding space; and providing a sheath flow adjacent the sample fluid flow and controlling, using the sheath flow, at least one of a size, location and/or a path of the sample flow in at least part of the holding space.

Here, and elsewhere in this disclosure, the acoustic wave preferably is a bulk acoustic wave, which enables exerting forces on an entire object, including biological objects such as cellular objects like a biological cell; the acoustic wave preferably is a standing acoustic wave, which provides a well-defined force profile in the sample holder across the sample. The acoustic wave may enable application of forces on objects in a direction away from a wall surface at least partly defining the holding space, in particular towards a node in the fluid medium in the sample holder. Preferably the acoustic wave may enable the application of forces of up to >1 nN onto objects such as biological cells in a direction which is perpendicular to the wall surface.

It has been found that in practice, in acoustic force sample holders, the acoustic wave in the holding space exerting a force on the sample may be uneven across the holding space. Also or alternatively, the holding space may provide otherwise locally varying conditions for at least part of the sample, e.g. at least part of the holding space being defined by a wall at least partly provided with a functionalised wall surface (see also below). The use of a sheath flow facilitates positioning and/or directing the sample fluid flow within the holding space which may take into account such local variations.

The sheath fluid flow and the sample fluid flow may flow in a laminar flow regime to avoid turbulence and/or mixing between the different fluid flows.

The sheath flow may comprise a first and second sheath flow portion on opposite sides of the sample fluid flow; possibly also a third and/or a fourth sheath flow portion on top and/or bottom sides of the sample fluid flow, relative to a position of an acoustic wave generator for generating the acoustic wave. The more sheath flow portions, the better the sample flow may be controlled.

The holding space is defined by a plurality of walls. The sample holder may comprise a first channel providing the holding space; e.g. the holding space may be formed by part of the channel defined by one or more of a particular size and/or shape, a circumference of the acoustic wave generator and a window portion for optical access to contents of the first channel; such window portion may be defined by a local surface marking such as presence or absence of a coating.

The sample holder may be a unitary device e.g. of glass- or crystal elements glass-bonded and/or fused together, or it may even be a monolithic device containing the holding space. The fewer structural interruptions (material interfaces and/car part-to-part transitions) the sample holder contains, the better acoustic energy may be transferred to and/or distributed through the sample holder and in particular in or into the holding space.

The objects in the sample may comprise biological objects, in particular cellular bodies and/or macromolecules like DNA-strands. Also or alternatively, the objects may comprise microbeads, possibly the objects comprising assemblies of one or more biological objects attached to one or more microbeads.

The sample holder may comprise a functionalized wall surface portion to which the objects in the sample can bind, see also below. The functionalized wall surface portion may comprise cellular bodies bound to the wall portion; e.g. the functionalized wall surface may comprise a cell (mono-)layer.

A suitable sample fluid flow may comprise the objects and/or any substance or further objects for engagement with the objects such as nutrients for biological objects, vectors and/or cellular bodies having a physical and/or (bio-)chemical reaction with the objects of the sample.

Also, a method of manipulating and/or investigating objects is provided, which may or may not be suitably combined with any other method provided herein, comprising: providing a sample holder comprising a holding space for holding a fluid medium; providing a sample comprising one or more objects in a fluid medium in the holding space;
generating an acoustic wave in the holding space exerting a force on the one or more objects of the sample in the holding space;
wherein providing a sample comprising one or more objects in a fluid medium in the holding space comprises providing the sample into the holding space along a first flow path in the sample holder, in particular by a sample fluid flow, and wherein the method further comprises
providing one or more second fluid flows in the sample holder along a second flow path, and in case of more second fluid flows each along a different respective second flow path, in particular during and/or after generating the acoustic wave in the holding space, wherein at least part of the one or more second flow paths and the first flow path pass through a common channel and/or the holding space, in particular crossing and/or intersecting the first flow path.

The method may comprise providing one or more second fluid flows through the holding space, and in case of more second fluid flows each along a different respective second flow path, in particular during and/or after generating the acoustic wave in the holding space, wherein each of the respective different second flow paths pass through the holding space, in particular crossing and/or or at least partly intersecting the first flow path in the holding space. Thus, the second fluid flow or -flows may remain substantially independent from, and unaffected by, fluid(s) and components therein along the first flow path, except for the part(s) sharing a common channel and/or for the location of the crossing and/or intersection of the first and second flow paths. Thus, “contamination” of at least part of the second fluid flow(s) by fluid from the first fluid flow path may be prevented. The same holds for more second fluid flows among each other. The first and second flow paths may share (part) one or more channels in the sample holder without crossing or intersecting in the channel (part) but may also, and preferably, be determined by independent first and second channels in the sample holder when crossing and/or intersecting in the holding space.

A second fluid flow may serve to introduce at least part of the sample into the holding space and/or in particular to remove at least part of the sample from the holding space, or into/from another part of the sample holder. The introduction and/or removal may be associated with, or as a function of, at least one parameter of the acoustic wave in the holding space, e.g. during generation of the acoustic wave in the holding space. Thus, an effect of the acoustic wave on the sample may be studied, wherein the second fluid flow may depend on time and/or position.

Note that, herein, flow paths refer to the (in particular shortest) fluid connection between a (local) flow source and a (local) flow drain through the sample holder defined by one or more channels and/or walls therein. Herein, “intersecting flow paths” means that the respective flow paths have at least one common point or section (including coinciding along part but not all of the lengths of the respective flow paths), whereas “crossing flow paths” means that, although the respective flow paths overlap when viewed in a direction perpendicular to these flow paths, they do not have a common point, e.g. running at different levels so that the flow paths do not intersect. A fluid source and fluid drain may be connected by multiple different channel portions in parallel each defining at least part of a fluid flow path (using “(connected) in parallel” as opposed to “(connected) in series”, without restriction to strict parallelism) wherein different such (at least part of the) flow paths between the fluid source and fluid drain may cross and/or intersect, possibly multiple times.

In case of adjacent flow paths in a shared channel part and/or in case of crossing flow paths, parts of fluid flows along the respective flow paths may intersect due to having a finite size in cross section perpendicular to the respective flow path, and objects from the sample may move from a first fluid flow along the associated first flow path into a second fluid flow along the associated second flow path, e.g. as a consequence of and/or under the influence of one or more of turbulence, mixing, diffusion and the application of the acoustic wave.

Crossing and/or intersecting flow paths, at least in the holding space, may extend substantially perpendicular to each other improving distinction between regions with and without (possible) (inter)action between the respective flows.

Providing a point of separation between the different flow paths for separating the different flow paths, directly in the holding space may improve separation of sample components. E.g., mixing due to dispersion of the sample fractions in fluidic conduits between the point of separation (i.e. in the holding space) and the sample collection point may be prevented. Flow dispersion is a well-known phenomenon in for example chromatography and can be caused by many different effects (e.g. diffusion, parabolic flow profiles, sticking to conduit walls, rolling due to gravity or buoyancy, etc.).

Also or alternatively, one or more of the second fluid flows may be combined with one or more associated sheath flows for microfluidic control of the respective second flow, as indicated above, for which the sample holder may suitably be provided with further sheath flow channel sections and associated inlets and/or outlets, respectively.

In one or more embodiments of such methods, one or more parameters of the acoustic wave are adjustable. The adjustability may be with respect to the step of providing the sample comprising the one or more objects in the fluid medium in the holding space, and/or with the step of providing a second fluid flow. The one or more parameters of the acoustic wave may be selected from application, power, amplitude, wavelength, frequency and variations thereof, and then the embodiment comprises providing the second fluid flow or at least one of the one or more second fluid flows, respectively, in dependence of at least one of the one or more parameters of the acoustic wave.

The parameters of the acoustic wave and their variations may in particular comprise presence (ON), absence (OFF), duration of generation and/or interval between successive periods of presence (e.g. pulse duration, inter-pulse interval, pulse repetition rate), amplitude, wavelength, wave power, as well as a rate of change of any one of the parameters, including variations in a rate of change (e.g. second derivative with respect to time). Any changes may be (near) instantaneous or gradual, which latter may be controllable.

Thus, in dependence of the parameters of the acoustic wave, different portions of the sample may be introduced into and/or removed from the holding space along different flow paths, which facilitates one or more of manipulation, selection and sorting of the different portions of the sample.

Also, a method of manipulating and/or investigating objects is provided, which may or may not be suitably combined with any other method provided herein, comprising: providing a sample holder comprising a holding space for holding a fluid medium; providing a sample comprising one or more objects in a fluid medium in the holding space, wherein the one or more objects may comprise biological objects, more in particular cellular bodies; generating an acoustic wave in the holding space exerting a force on the one or more objects of the sample in the holding space;
wherein providing a sample comprising one or more objects in a fluid medium in the holding space comprises providing the sample into the holding space along a first flow path in the sample holder through a first channel, in particular by a sample fluid flow, and
wherein the method further comprises providing an interaction substance source such as a nutrient source and/or interaction moiety source in a reservoir in the sample holder, establishing a fluid contact between the source and the sample and providing at least some of the interaction substance to the objects by diffusion via a diffusion channel between the reservoir and the holding space, wherein in particular the holding space is devoid of net fluid flow.

For biological objects it may be relevant to keep at least some of the objects alive for which nutrients may be essential. It has been found that biological objects, in particular cellular bodies, may respond adversely to being exposed to flow of a fluid past the bodies, e.g. by deforming and/or changing biological processes (also known as “stress” behaviour, even for single cells). It has been found that such adverse reactions may be reduced by reducing flow rate. Although a low flow velocity, e.g. on the order of tens nanoliters per minute, may be provided, providing the nutrients via diffusion rather than by flowing of a nutrient-containing fluid may therefore be preferred. The same applies to interaction moieties (see also below).

A reservoir separate from the holding space and a source separate from the sample facilitate independent control over each. It also or alternatively allows providing at least some of the nutrients and/or interaction moieties from the source to the objects in the holding space in a controlled fashion; e.g. at a controlled time and/or variation. The reservoir and the holding space may be arranged adjacent each other and/or be part of independent flow paths and/or flow channels, e.g. a flow path not extending through the holding space. Preventing net fluid flow facilitates reduction or prevention of flow stress on the objects.

A diffusion channel may be provided and extend perpendicular to one or more of such flow paths and/or channels. Such diffusion channel may be designed to allow the nutrients and/or interaction moieties to pass but to prevent the objects to pass so as to set up a substantially one-directional system. Plural such diffusion channels may be provided to facilitate and/or increase diffusion; this may be done by appropriately sizing the diffusion channel and/or by providing the diffusion channel with a physical and/or (bio)chemical filter and/or driving means such as electromagnetic fields and; or coatings and/or membranes.

Any method herein may further comprise providing the holding space with a functionalised wall surface portion to be contacted by the sample and the sample being in contact with the functionalised wall surface portion during at least part of the step of application of the acoustic wave. This may in particular be provided in case the one or more objects comprise biological objects, more in particular cellular bodies.

The objects may be at least partly functionalised, e.g. microbeads provided with interaction moieties. However, it may be preferred that the objects in the sample comprise biological objects, more in particular cellular bodies. Combinations of non-living objects like silica microbeads and biological objects like cellular bodies, possibly attached to one another via suitably interacting moieties, may be used as well.

Thus, interaction of the objects in the sample, in particular one or more cellular bodies, with the functionalised wall surface portion may be studied, e.g. a relation of adhesion of the object to the functionalised wall surface portion and (the force of) the acoustic wave. Also or alternatively at least some of the objects may be separated based on differences in interaction with the functionalized wall surface.

E.g., one or more embodiments may comprise detecting one or more signals indicative of adhesion and/or detachment of at least one of the one or more objects to/from at least part of the sample holder, in particular part of the holding space more in particular a wall of the holding space, preferably the functionalized wall surface portion if present.

Also or alternatively one or more embodiments may comprise detecting the one or more signals indicative of adhesion and/or detachment of at least one of the one or more objects to/from at least part of the sample holder as a function of at least one parameter of the acoustic wave selected from duration of application, power, amplitude and frequency.

Also or alternatively one or more embodiments may comprise separating at least one object from the one or more objects, based on at least one parameter of the acoustic wave, wherein the parameter may be selected from one of duration of application, power, amplitude and frequency.

One or more of such methods allows in particular studying bonding forces of cellular bodies to the functionalised wall portion; the entire contact surface of a cellular body with the wall portion may be probed at once. This relates to the amount of bonds, the type of bonds and the bonding force per bond. Moreover, plural cellular bodies may be studied simultaneously which may provide statistical distribution information within one or a few measurements. Also or alternatively, such method allows utilizing such bonding forces for one or more of characterization, identification and separation of at least some of the cellular bodies in a sample, based on (properties and/or differences of) the bonding force.

The cellular bodies may be cell portions like subcellular organelles, cell nuclei, and/or mitochondria. However, the cellular bodies may also be unicellular or pluricellular, such as small clumped cell groups, plant or animal biopts, dividing cells, budding yeast cells, lymphocytes, colonial protists, etc. The cellular bodies may also be animal embryos in an early stage of development (e.g. the morula-stadium of a mammal, possibly a human embryo). In particular cases different types of cellular bodies may be studied together. E.g., cellular bodies from a mucosal swab, blood sample, or other probing techniques could be used; also or alternatively, the functionalisation may be or comprise a (suspected) tumor cell (mono-)layer, e.g. in case the objects comprise T-cells, or the other way around.

The sample fluid may be any fluid substance in which the cellular body can move under the influence of an acoustic force and within the time scale of an acoustic force study, the cellular bodies should be able to fall through the fluid to a wall portion of the sample holder, in particular fall to or from the functionalised wall portion dependent on the spatial orientation of the sample holder and the direction of the acoustic force; the objects can potentially fall or float based on gravity and density differences or can potentially also be driven towards or from the functionalised wall by applying a suitable acoustic frequency generating a standing wave with an according pressure gradient towards the wall portion. Note that an acoustic force study may generally last from sub-seconds time periods to several hours and possibly even days; motion of cellular bodies in a range of sub-seconds to seconds is preferred. The fluid should be capable of transmitting and sustaining ultrasound waves for prolonged periods. Suitable fluids are liquids and gels, e.g. water, watery fluids, bio-compatible solvents, oils, gels, hydrogels and bodily fluids, although sufficient optical clarity to allow imaging may be desired in any embodiment using optical studying (see also below).

Suitable interaction moieties may comprise an antibody for selective binding to a particular target, e.g. a microbial cell or a cancer cell. E.g., specific antibodies exist for several major hospital infections and several tumour strains. Such interaction moiety may normally be effective to deliver a conjugate of the interaction moiety to a predetermined pathological site in a mammal. A pathological site may comprise a target moiety which, together with the interaction moiety, constitutes a specific binding pair. In the present case the interaction moiety may be attached to the wall in the functionalised wall portion, e.g. by direct attachment or by forming the interaction moiety from or with a primer, and a binding pair may have sufficient binding force to adhere the cellular body to the functionalised wall portion.

The interaction moiety may comprise an antibody, or an antibody fragment that binds to a cell-surface antigen, or a ligand or ligand fragment that binds specifically to a cell surface receptor. From this group anti bodies, or antibody fragments, that bind to a cell-surface antigen may be preferred because of their binding selectivity. For instance, cancer cells usually have tumor associated antigens on their surface. Their complementary antibodies will bind very selectively to these tumor associated antigens. Ligand or ligand fragments however are also suitable. Various peptides are known to bind their cognate receptors with high affinity and thus would be suitable ligands for conjugation to the radioisotopes of the invention. Receptors are plasma membrane proteins which bind molecules, such as growth factors, hormones and neurotransmitters. Tumors develop from particular cell types which express certain subsets of these receptors. Taking advantage of this binding affinity between receptor and ligand enables target-specific studies and/or identification of cellular bodies.

Similarly, immune responses rely on a complex interaction cascade between immune cells and their cell surfaces. For instance, B-cell activation depends on the binding of the B-cell receptor expressed on the B-cells surface to an antigen exposed on the surface of an antigen-presenting cell (APC). This in turn triggers a cascade of intracellular and intercellular events that leads to antibody secretion and pathogen attack by the complement system. Likewise, T-cell activation occurs via the interaction of an antigen on the surface of an APC with the T-cell receptor on the T-cell surface. Furthermore, T-cells recruitment to inflammatory/infected sites relies on the extravasation of T-cells from the bloodstream into tissue. Extravasation is initiated by a cytokine-regulated multistep adhesion process to the vascular epithelium followed by transmigration through the cell wall of blood vessels. Cellular bodies may bind to a wall surface functionalized with a single type of interaction moiety (e.g. a single type of antigen or antibody) or with multiple different types of interaction moiety. The same is true if the functionalized wall surface is formed by antigen presenting cells (e.g. a tumor cell monolayer) which typically have multiple different types of antigens and/or receptor molecules on their surface. In the case studies of the interaction strength of a cellular body to multiple interaction moieties simultaneously (either multiple moieties of a single type or multiple moieties of different types) the interaction strength may be characterized as an avidity. Immunodeficiency and autoimmune diseases represent a misbalance in immune response. In all processes that can lead to abnormal immune response, e.g. altered lymphocyte activation, cell-adhesion, cell-migration and pathogen attack, the interaction of bio-molecules on the cell surface with binding partners in the extracellular environment is essential.

Some representative examples of receptor-ligand pairs are set forth below:

| RECEPTOR | LIGAND |
|---|---|
| Epidermal growth factor | epidermal growth factor |
| receptor | (53 amino acids) |
| Platelet derived Growth | platelet derived growth factor |
| factor receptor | |
| Insulin like growth factor | insulin-like growth factor |
| receptor | |
| Glucagon growth factor | glucagon (23 amino acids) |
| receptor | |
| Vasopressin receptor | vasopressin (9 amino acids) |
| A thyroid stimulating | thyroid stimulating hormone |
| Hormone receptor | |
| Insulin receptor | insulin |
| T-cell receptor (TCR) | Peptide- major histo-compatibility |
| | (MHC)complex |
| Chimeric antigen receptor | CD19 |
| (CAR) | |

The acoustic wave may be an ultrasound wave, e.g. having a frequency in a range of 1-30 MHz, preferably in a range 5-20 MHz such as 7-15 MHz. Preferably, the wavelength of the acoustic wave in the sample holder is on the order 10 to 100 times the size of the particles. The acoustic wave may be a standing wave, at least during part of the method. The acoustic wave may be arranged for applying an acoustic force to the one or more particles. Applying an acoustic force to the one or more particles may form (part of) a step of the method, wherein the acoustic force may be provided at a strength sufficient to move one or more particles and/or to counteract another force on the one or more particles. E.g., for manipulating a human T-cell, an acoustic force on the order of around 100 pN or more to the T-cell may be preferred.

Associated with the foregoing and any aspects and benefits discussed therein, herewith also systems for manipulating and/or investigating objects, in particular biological objects such as cellular bodies, are provided, as follows.

A system for manipulating and/or investigating objects is herewith provided, in particular biological objects such as cellular bodies. The system comprising a sample holder comprising a holding space for holding a sample comprising one or more objects in a fluid medium, and an acoustic wave generator connected with the sample holder to generate an acoustic wave in the holding space exerting a force on at least part of the sample, wherein the sample holder comprises a first microfluidic sample channel provided with a fluid inlet and a fluid outlet for generating a sample fluid flow of the fluid medium through the holding space, and wherein the sample holder further comprises
a first microfluidic channel portion for generating a first sheath flow portion in at least part of the first channel and the holding space adjacent the sample flow, and
a second microfluidic channel portion for generating a second sheath flow portion in at least part of the first channel and the holding space adjacent the sample flow opposite from the first sheath flow.

By provision of the first and second channels for the first and second sheath flow portions, a sheath flow as a whole may be controlled and therewith the sample flow may be controlled which may facilitate positioning and/or directing the sample fluid flow within the holding space and/or the first channel. Preferably, the first and second sheath flow portions and the sample flow combined and individually form a laminar flow so that no or negligible mixing of the different flows occurs. Preferably, the system comprises at least one controller for individually controlling at least the sample flow and the first and second sheath flow portions, although the latter two may also be controlled together. For optional further sheath flow portions in addition to the first and second sheath flow portions the same holds.

Here, a channel may comprise a channel and/or a portion of the first channel appropriately shaped for providing a sheath flow, e.g. by reducing chances of turbulent flow.

The acoustic wave generator is preferably configured to provide the acoustic wave in a direction perpendicular to the flow channel and a direction of the sample flow and more in particular in a direction perpendicular to a plane comprising at least part of the sample flow and the first and second sheath flow portions.

Also a system for manipulating and/or investigating objects, in particular biological objects such as cellular bodies, is provided, which may or may not be suitably combined with any other system provided herein, comprising a sample holder comprising a holding space for holding a sample comprising one or more objects in a fluid medium, and an acoustic wave generator connected with the sample holder to generate an acoustic wave in the holding space exerting a force on at least part of the sample, wherein the sample holder comprises
a first microfluidic channel provided with a first fluid inlet and a first fluid outlet and defining a first flow path in the sample holder from the first inlet to the first outlet, and
a second microfluidic channel comprising a second fluid inlet and a second fluid outlet and defining a second flow path in the sample holder from the second inlet to the second outlet,
such that at least part of the first and second flow paths pass through a common channel and/or the holding space.

Such system enables provision of first and second fluid flows interacting and/or crossing or at least partly intersecting in the sample holder, in particular in the holding space. Thus, at least part of a sample in the sample holder and in particular in the holding space may be affected by fluid along the second flow path independent from (potential substances in) the fluid in the first channel.

Preferably, the first and second channels are arranged such that the first and second flow paths, at a crossing and/or intersection, and then preferably when in the holding space, extend substantially perpendicular to each other. This may facilitate localising and/or minimizing common volume of fluid flows along the two flows paths.

In at least one embodiment of such system, the sample holder comprises a plurality of microfluidic channels provided with an inlet and/or an outlet, each of the plurality of microfluidic channels defining at least part of a flow path in the sample holder from a respective inlet to a respective outlet, such that each respective separate flow path crosses and/or intersects the first flow path, in particular crossing and/or intersecting the first flow path in the holding space.

Also or alternatively, in at least one embodiment of such system, a plurality of microfluidic channels provided with an inlet and/or an outlet, each of the plurality of microfluidic channels defining at least part of a separate flow path in the sample holder from the respective inlet to the holding space and/or from the holding space to the respective outlet, such that each respective separate flow path crosses and/or intersects the first flow path in the holding space.

Such system facilitates manipulating substances and/or sample portions and/or facilitates introducing different substances into the holding space. Also or alternatively, such system facilitates selecting and/or sorting at least some portions of the sample from the holding space.

Also or alternatively, in at least one embodiment of such system, the system comprises a controller connected with the acoustic wave generator and being configured to control one or more parameters of the acoustic wave, and wherein the system comprises a fluid flow controller connected to the inlets and outlets of the sample holder and being configured for providing a fluid flow along each of the respective flow paths, in particular in dependence of at least one of the one or more parameters of the acoustic wave.

Such system facilitates manipulating and/or selecting and/or sorting at least some portions of the sample from the holding space in dependence of the selected parameters of the acoustic wave.

Also a system for manipulating and/or investigating objects, in particular biological objects such as cellular bodies, is provided, which may or may not be suitably combined with any other system provided herein, comprising a sample holder comprising a holding space for holding a sample comprising one or more objects in a fluid medium, and an acoustic wave generator connected with the sample holder to generate an acoustic wave in the holding space exerting a force on at least part of the sample, wherein the sample holder comprises at least one nutrient and/or interaction substance reservoir, and at least one a diffusion channel connecting the reservoir to the holding space separate from the first channel, preferably one or more diffusion channels connecting the reservoir with the holding space, in particular a plurality of diffusion channels being arranged on opposite sides of the holding space.

From the reservoir in the sample holder, reagents may be provided to the holding space, and in particular separate from (a channel for) a fluid flow via one or more diffusion channels. E.g. biological objects in the sample may be provided with nutrients and/or interaction moieties without exposing a sample in the holding space to a fluid flow. The diffusion channel(s) may have a small cross-sectional size compared to the holding space and/or the first channel, so that a net fluid flow through the diffusion channel(s) is hindered. Plural diffusion channels reduce the diffusion path length and improve provision of the nutrients and/or interaction moieties to the holding space with respect to amount and/or homogeneity thereof. This is in particular the case if the diffusion channels are arranged on opposite sides of the holding space and/or the first channel, when present.

Also a system for manipulating and/or investigating objects, in particular biological objects such as cellular bodies, is provided, which may or may not be suitably combined with any other system provided herein, comprising a sample holder comprising a holding space for holding a sample comprising one or more objects in a fluid medium, and an acoustic wave generator connected with the sample holder to generate an acoustic wave in the holding space exerting a force on at least part of the sample, wherein the sample holder comprises a first microfluidic channel provided with a fluid inlet and a fluid outlet for generating a sample fluid flow of the fluid medium through the holding space and wherein the sample holder comprises one or more microfluidic channels provided with at least one of an inlet and an outlet and being connected with the first channel remote from the holding space for providing a fluid flow in and/or through at least part of the first channel offset from and not through the holding space.

Such system facilitates affecting and/or possibly adjusting and/or exchanging a fluid in at least part of the first channel, therewith reducing risks of “contamination” (as explained elsewhere in this disclosure) of one or more portions of the sample. And also avoiding the shear stress which objects/cellular bodies may experience in the first channel caused by flow of fluid. It also facilitates flushing and cleaning of the input and/or output microfluidics without perturbing the sample in the holding space. It also enables the use of fast flow for an extended period of time to ensure a small packet of objects flushed out of the holding space (e.g. after they released from the functionalized wall surface at a specific force) to be fully flushed into a collection reservoir without the need of providing flow for extended periods through the holding space. This avoids perturbing the sample and allows better sorting/fractionation of objects by mitigating some of the effects from flow dispersion as mentioned above.

### BRIEF DESCRIPTION OF THE DRAWINGS

The above-described aspects will hereafter be more explained with further details and benefits with reference to the drawings showing a number of embodiments by way of example.

FIG. 1 is a schematic drawing of an embodiment of a manipulation system;

FIG. 2 is a schematic drawing of a sample holder for the system of FIG. 1;

FIG. 2A is a schematic detail of FIG. 2 as indicated;

FIGS. 3-11 show a workflow for acoustic force measurements;

FIG. 12 shows an embodiment of a sample holder for use in the system of FIG. 1;

FIG. 13-14 show an embodiment for flow focusing using sheath flows;

FIG. 15-19 show embodiments of sample holders and workflows;

FIGS. 20-22 show embodiments of a sample holder and workflow steps in cross section;

FIGS. 23-24 show a cross section of part of a holding space during a method disclosed herein.

### DETAILED DESCRIPTION OF EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with alphabetic suffixes.

Further, unless otherwise specified, terms like “detachable” and “removably connected” are intended to mean that respective parts may be disconnected essentially without damage or destruction of either part, e.g. excluding structures in which the parts are integral (e.g. welded or molded as one piece), but including structures in which parts are attached by or as mated connectors, fasteners, releasable self-fastening features, etc. The verb “to facilitate” is intended to mean “to make easier and/or less complicated”, rather than “to enable”.

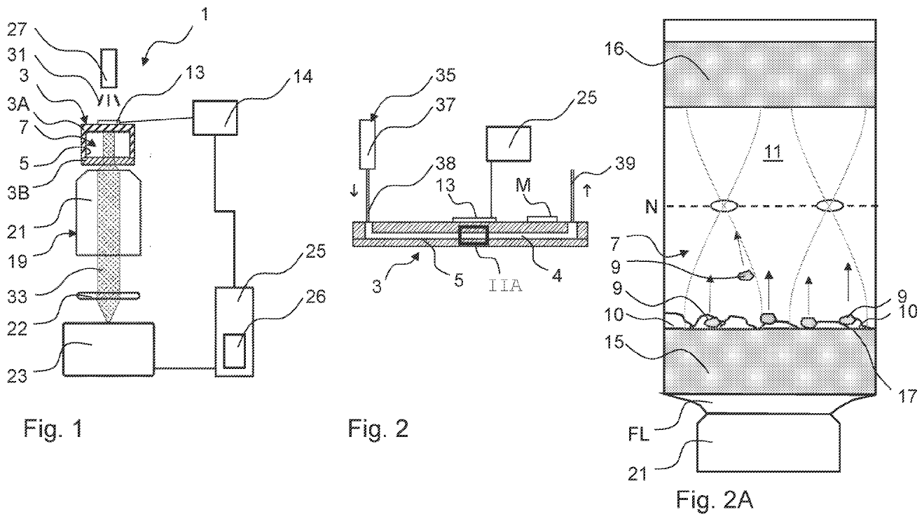

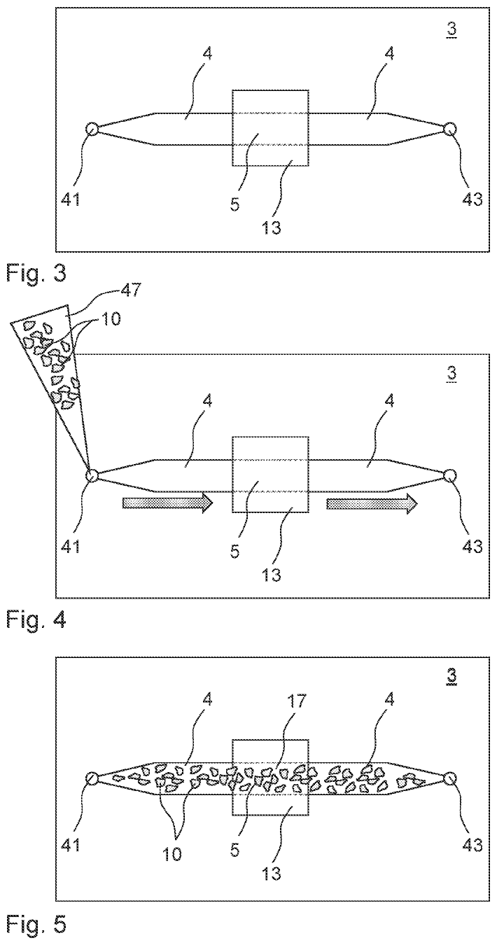

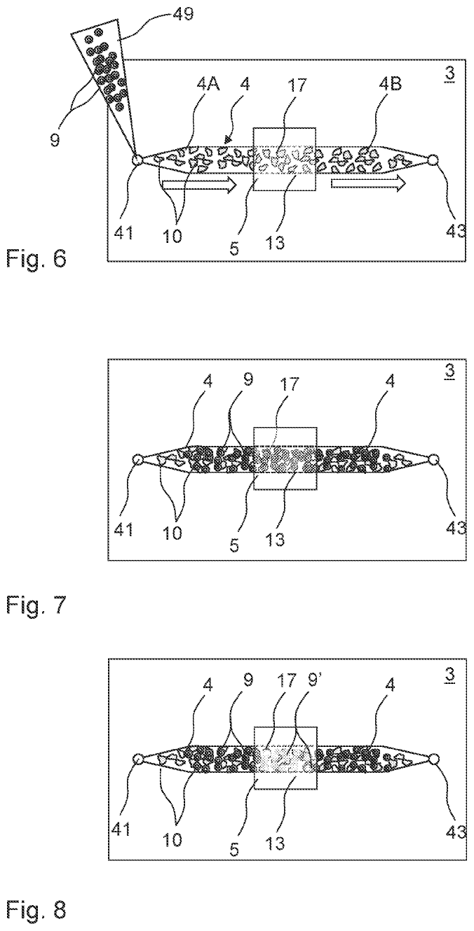

FIG. 1 is a schematic drawing of an embodiment of a manipulation system 1 in accordance with the present concepts, FIG. 2 is a cross section of a sample holder and FIG. 2A is a detail of the sample holder of FIG. 2 as indicated with “IIA”.

The system 1 comprises a sample holder 3 comprising a holding space 5 for holding a sample 7 comprising one or more objects like biological cellular bodies 9, in a fluid medium 11 as exemplary particles of interest. It is noted that also, or alternatively, other types of particles like microspheres could be used, possibly attached to biological cellular bodies 9. Microspheres of polymeric and/or glass material (hollow and/or solid) may be suitable objects; such microspheres may be coated wholly or in part with any suitable coating and/or primer. The fluid preferably is a liquid or a gel. The system 1 further comprises an acoustic wave generator 13, e.g. a piezo element, connected with the sample holder 3 to generate an acoustic wave in the holding space exerting a force on the sample 7 and cellular bodies 9 in the sample 7. The acoustic wave generator 13 is connected with an optional controller 14 and power supply, here as an option being integrated.

The sample holder 3 comprises a wall 15 providing the holding space 5 with an optional functionalised wall surface portion 17 to be contacted, in use, by part of the sample 7. Here, the functionalised wall surface portion 17 is provided with the cellular bodies 10 adhered to the surface of the wall 15, possibly with one or more primer layer in between (not shown). As explained in more detail below, interaction of the cellular bodies 9 (and/or other objects) with the cellular bodies 10 may be studied with the systems and methods. A further wall, e.g. opposite wall 16, may also or alternatively be provided with a (further) functionalised wall surface portion.

The shown manipulation system 1 comprises a microscope 19 with an optional optical system such as an (optionally adjustable) objective 21 and a camera 23 connected with a computer 25 comprising a controller and a memory 26; more or less optical detectors and/or detectors of other types may be provided. The computer 25 may also be programmed for tracking one or more of the cellular bodies based on signals from the camera 23 and/or for performing microscopy calculations and/or for performing analysis associated with (super resolution) microscopy and/or video tracking, which may be sub-pixel video tracking. The computer or another controller (not shown) may be connected with other parts of the system 1 (not shown) for controlling at least part of the microscope 19 and/or another detector (not shown). In particular, the computer 25 may be connected with one or more of the acoustic wave generator 13, the power supply thereof and the controller 14 thereof, as shown in FIG. 1. The computer may also be connected to one or more fluidics valves, pressure/flow sensors, pressure regulators, etc. in order to facilitate control over fluid flows. This enables also specific flow protocols to be incorporated into the experimental protocols and/or enables automation of flow based on detection of certain events by the system. Such events may comprise changes in at least part of a sample, e.g. changes in position and/or movement of one or more objects in the sample such as (induced by and/or otherwise associated with) adhesion and/or detachment of the one or more objects to/from the functionalised wall surface.

The system further comprises an optional light source 27. The light source 27 may illuminate the sample 7 using any suitable optics (not shown) to provide a desired illumination intensity and intensity pattern, e.g. plane wave illumination, Köhler illumination, etc., known per se. Here, in the system light 31 emitted from the light source 27 is directed through the acoustic wave generator 13 to (the sample 7 in) the sample holder 3 and sample light 33 from the sample 7 is transmitted through the objective 21 and through an optional ocular 22 and/or further optics (not shown) to the camera 23. The objective 21 and the camera 23 may be integrated. In an embodiment, two or more optical detection tools, e.g. with different magnifications, may be used simultaneously for detection of sample light 33, e.g. using a beam splitter. The computer may also be connected to the light source 27 e.g. in order to synchronize the light source with the camera.

In another embodiment, not shown but discussed in detail in WO 2014/200341, the system comprises a partially reflective reflector and light emitted from the light source is directed via the reflector through an objective and through the sample, and light from the sample is reflected back into the objective, passing through the partially reflective reflector and directed into a camera possibly via intervening optics. Further embodiments may be apparent to the reader.

The sample light 33 may comprise light 31 affected by the sample (e.g. scattered and/or absorbed) and/or light emitted by one or more portions of the sample 7 itself e.g. by fluorophores attached to the cellular bodies 9 or e.g. generated by bio-, or chemo-luminescence.

Some optical elements in the system 1 may be at least one of partly reflective, dichroic (having a wavelength specific reflectivity, e.g. having a high reflectivity for one wavelength and high transmissivity for another wavelength), polarisation selective and otherwise suitable for the shown setup. Further optical elements e.g. lenses, prisms, polarizers, diaphragms, reflectors etc. may be provided, e.g. to configure the system 1 for specific types of microscopy.

As shown in FIGS. 1 and 2, the sample holder 3 may comprise a part 3A that has a recess being, at least locally, generally U-shaped in cross section and a cover part 3B to cover and close (the recess in) the U-shaped part providing a channel 4 and an enclosed holding space 5 in cross section.

The sample holder 3 preferably is a substantially planar device, more preferably a microfluidic device of the type commonly referred to as a lab-on-a-chip. At least part of the sample holder may be formed by a single piece of material with a channel inside, e.g. glass, injection moulded polymer, etc. (not shown) or by fixing different layers of suitable materials together more or less permanently, e.g. by welding, glass bonding/direct bonding, gluing, taping, clamping, etc., such that a holding space 5 is formed in which the fluid sample 7 is contained, at least during the duration of an experiment. Forming the sample holder from a single piece of material may have the advantage that it forms an efficient acoustical cavity which enables the generation of high acoustic forces at the functionalized wall. Thus, a monolithic sample holder, at least at the location of the acoustic wave generator 13, may be preferred over an assembled sample holder for improving acoustic coupling, reducing losses and/or preventing local variations.

As shown in FIG. 2, the sample holder 3 is connected to an optional fluid flow system 35 for introducing fluid into the holding space 5 of the sample holder 3 and/or removing fluid from the holding space 5, e.g. for flowing fluid through the channel 4 and holding space 5 (see arrows in FIG. 2), The fluid flow system 35 may comprise a manipulation and/or control system, possibly associated with the computer 25. The fluid flow system 35 may comprise one or more of reservoirs 37, pumps, valves, and inlet conduits 38 for introducing one or more fluids and outlet conduits 39 for removing one or more fluids, sequentially and/or simultaneously. The sample holder 3 and the fluid flow system 35 may comprise connectors, which may be arranged on any suitable location on the sample holder 3, for coupling/decoupling without damaging at least one of the parts 3, 35, and preferable for repeated coupling/decoupling such that one or both parts 3, 35 may be reusable thereafter. Further, an optional machine-readable mark M or other identifier is attached to the sample holder 3, possibly comprising a memory.

FIG. 2A is a schematic of cellular bodies 9 in the sample holder 3 of FIG. 2. Part of the wall 15 of the sample holder 3 is optionally provided with a functionalised wall portion 17, e.g. an area of the area being covered with biological cells 10 of a different type to which the cellular bodies of interest 9 may adhere. Also shown is part of the microscope lens 21 and an optional immersion fluid layer FL for improving image quality.

On providing a periodic driving signal to the acoustic wave generator 13 a standing wave is generated in the sample holder 3. The signal is selected such that an antinode of the wave is generated at or close to the wall surface (of the sample holder 3 e.g. surface portion 17) and a node N of the wave W away from the surface 17, generating a local maximum force F on the bodies 9 at or near the surface towards the node. Thus, as explained in detail in WO 2018/083193, application of the signal may serve to probe adhesion/detachment of the bodies 9 to the surface and/or any functionalised layer on it in dependence of the strength of the force.

The optimal force generation may be achieved by designing optimizing the acoustic cavity parameters and the frequency/wavelength of the acoustic wave such as to create a maximum pressure gradient at the functionalized wall surface (e.g. by ensuring the distance from the wall surface to the acoustic node is ¼ wavelength).

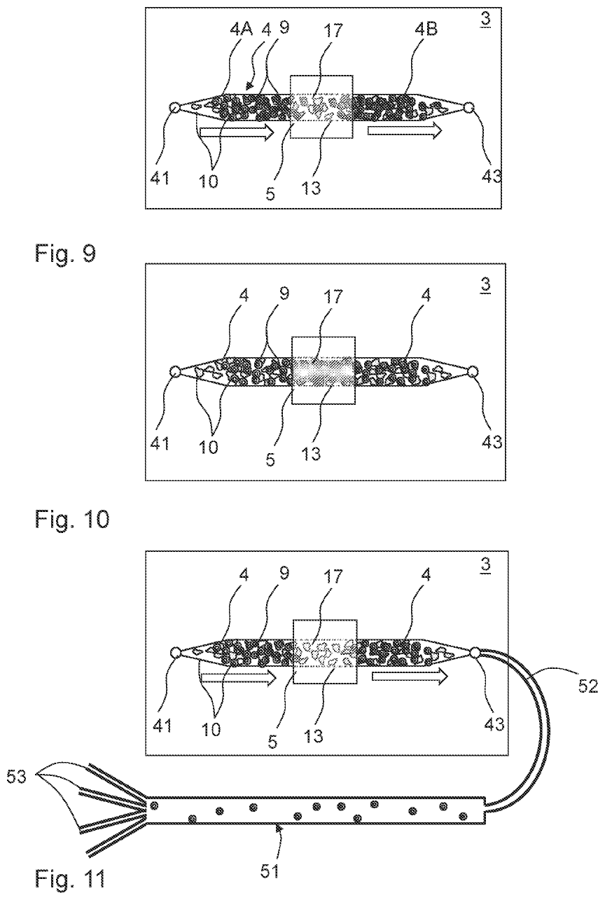

FIGS. 3-5 indicate a top view of a sample holder 3 and indicate exemplary method steps. As indicated in FIGS. 3-5, an acoustic force sample holder 3 may comprise a single channel 4. The holding space 5 may be determined by a shape variation in the channel, and/or by the location of the acoustic wave generator 13 and/or of a window for imaging etc. overlapping part of the channel 4. In the shown embodiment, the channel 4 comprises an inlet 41 and an outlet 43 for connection to the conduits 38, 39 (FIG. 1).

FIGS. 4 and 5 indicate loading the channel 4 and the holding space 5 with a sample fluid and target cells 10 via the inlet 41, e.g. using the conduit 38 and/or another fluid supply 47 such as a pipette. The target cells 10 are distributed over the channel 4 and the holding space 5 and left to settle there on a wall of the sample holder 3. Thus, a functionalised wall surface portion 17 is formed, see FIGS. 5 and 6 cf. FIG. 2k Formation of the functionalised wall surface portion 17 may comprise further suitable steps such as giving the target cells time to attach to the surface and grow into a monolayer. Also, a functionalised wall surface portion 17 may (be formed to) comprise different portions and/or portions with different properties.

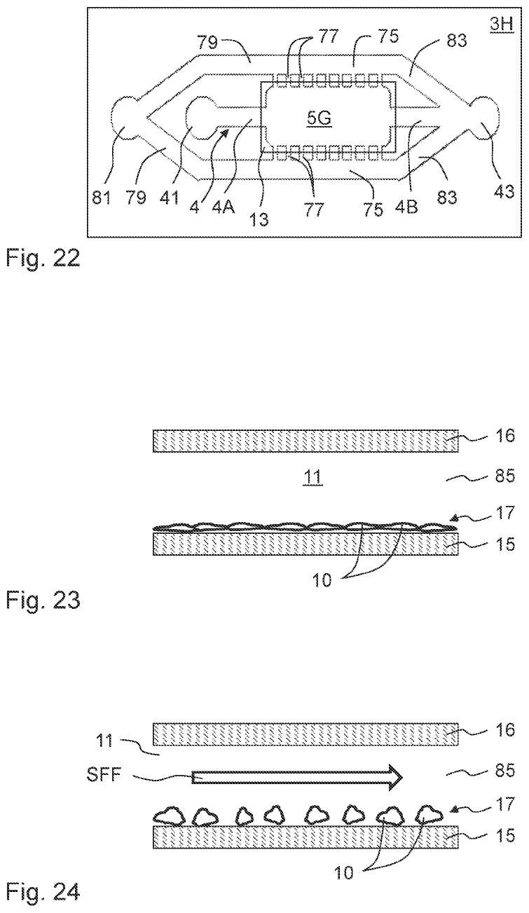

The functionalised wall surface portion 17 tends to be distributed over the channel 4 beyond the holding space 5, and may include conduits 38 and/or 39 if used. The loaded cells 10 may be incubated and/or cultured in the channel 4. However, it has been found that loaded cells 10 may be (negatively) affected if the medium is not refreshed during incubation/culturing. Also, a fluid flow through the channel 4 and holding space 5 may cause motion stress on the cells 10. In particular, the cells may at least partly detach from the surface and/or (attempt to) assume a spherical shape to minimise surface area and/or reduce contact to other surfaces, including neighbouring cells. This may affect (further) experimental results and/or cause deformation and/or structuring of the layer 17. See also FIGS. 23-24 discussed below. Flow rates over a few tens of nanoliters per minute in microfluidic channels and/or shear stress levels over 1 mPa may need to be avoided in order not to negatively affect the cells,

FIG. 6 indicates, some later time, loading a sample comprising objects 9 such as effector cells 9 or other cellular bodies in a sample fluid into the holding space 5 from a supply 49 and/or conduit 38 via the channel 4 (see arrows). During the loading, care may be taken to fill not only a lead-in section 4A of the channel 4 upstream of the holding space 5 but also a lead-out section 4B of the channel 4 downstream of the holding space 5 to ensure that the cells 9 pass through and into the holding space 5.

FIG. 7 indicates that the effector cells 9 may be allowed to settle and/or interact with the target cells 10. Again, the thus prepared sample may be stored and/or cultured in the channel 4 with or without (sample) fluid flow, which may (further) affect at least some of the target cells 10 and/or the effector cells 9.

FIG. 8 indicates generating an acoustic wave in the holding space 5 by the acoustic wave generator 13 connected with the sample holder 3, thus exerting a force on the cellular bodies 9, 10 of the sample in the holding space 5. The acoustic force is, as a preferred option, adjusted such that part of the cells 9 are forced from the functionalised wall surface 17 towards the node in the sample fluid (indicated as cells 9′ with a lighter colour), while cells 9 that are stronger bound to the functionalised wall surface 17 may remain adhered (cf. FIG. 2A). Thus, a separation is made between different types of effector cells 9 based on adhesion characteristics; unbound or loosely bound vs. strongly bound.

FIG. 9 shows that the detached cells 9 may be flushed out of the holding space 5 and removed from the sample holder 3 at the outlet 43 and collected. If so desired, thereafter a further acoustic wave may be provided in the holding space 5, e.g. stronger than the first to detach stronger bound cells not detached before, which later-detached cells may be separately collected.

Note that between successive and/or stronger acoustic wave periods in the holding space 5 one or more sample modifications may have been provided and/or further instances may have been allowed to happen and/or caused to happen as part of a measurement, therapy and/or experiment, e.g. one or more of settling, aging, reaction, interaction, cultivation, heating, cooling, irradiation, and/or other (bio-)physical and/or (bio-)chemical processes.

As will be appreciated from FIG. 9, the cells 9 detached in the holding space 5 will have to travel through lead-out section 4B of the channel 4 between the holding space 5 and the outlet 43. Thus, the sample portion of sample fluid and cells 9 may become contaminated and/or entrained cells 9 may get lost, e.g. further interaction between the different types of cells 9, 10 may occur which may be undesired and/or cells 9 may (otherwise) get stuck onto the cells 10 and/or cells 10 may become detached and flush out together with the flushing fluid and desired cells 9.

Note that the terms “inlet” and “outlet” may generally relate to the direction of a fluid flow through the respective structure, unless one or more one-way flow direction elements (valves, pumps, etc.) are provided. E.g., in a variant to the process described above with respect to FIGS. 8-9, during or after application of the acoustic wave, a fluid flow direction may be reversed and the inlet 41 may serve as outlet, whereas outlet 43 may serve as inlet for fluid.

Moreover, as FIG. 10 indicates, it has been found that, in practice, the acoustic force may not be distributed evenly over the holding space but that local force variations may occur. For example, the acoustic force at the center of the holding space may be higher than at the edges of the holding space. Therefore not all cells in the holding space may be experiencing the same force at the same time. Moreover, cells 9 with different detachment characteristics may be collected as one batch after flushing out (cf. FIG. 9). Also or alternatively, flow effects in the sample holder channel 4 and/or holding space 5 may cause uneven distribution of functionalisation moieties for establishing the functionalised wall surface portion 17 and/or uneven distribution of the objects 9 and/or uneven flushing out of detached cells 9 may occur. Such imperfections should be reduced and/or prevented; the more specific the force and/or time characteristics of the detachment are and/or the better one or more of these are known and/or controlled, the more specific the selection of objects 9 may be and the more precise effects may be studied and/or used.

FIG. 11 shows an option for selecting different portions of objects 9 studied with the sample holder 3: a splitter 51 is connected to (the outlet 43) of the sample holder 3, e.g. using tubing 52. The splitter 51 comprises a plurality of outlets 53 for selected batches of objects 9 removed from the sample holder 3. The splitter 51 may comprise one or more valves (not shown) and/or more or less outlets 53.

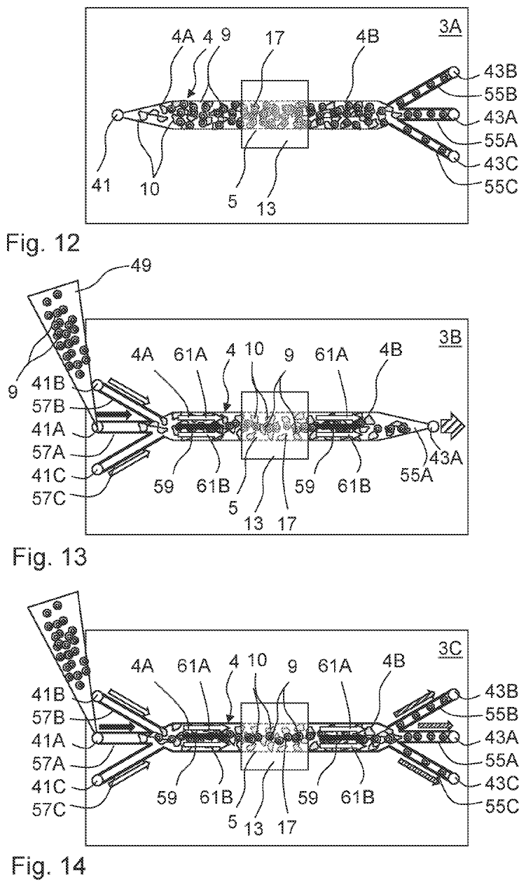

FIG. 12 shows an embodiment of a sample holder 3A wherein instead of the splitter 51 of FIG. 11, plural fluid outlets 43A-43C may also be integrated into the sample holder 3, connected with the channel 4 and the holding space 5 via individual microfluidic channels 55A-55B. This facilitates reduction of channel lengths so that smaller amounts of (possibly dangerous, delicate and/or expensive) fluids may be used and sample portions may be better selectable, e.g. by reduction or prevention of dispersion.

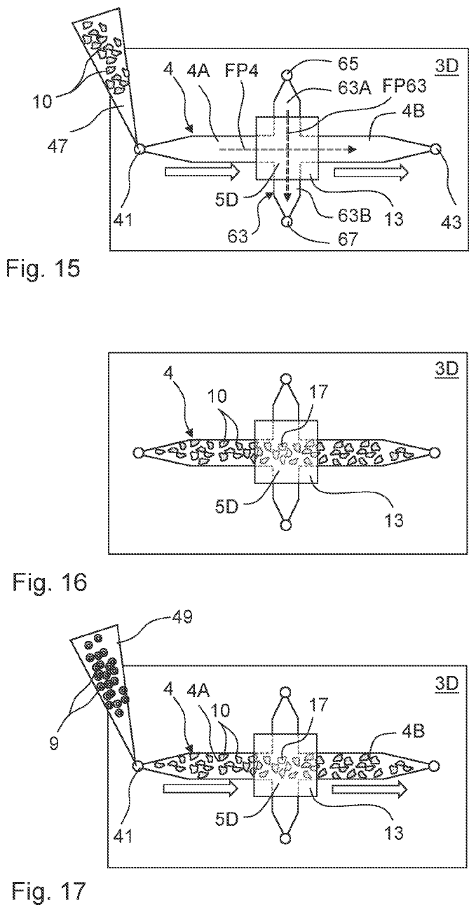

FIG. 13 shows a sample holder 3B for microfluidic control. The sample holder 3B comprises a holding space 5 for holding a sample comprising one or more objects 9 in a fluid medium, and an acoustic wave generator 13 connected with the sample holder 3 to generate an acoustic wave in the holding space 5 exerting a force on the sample. Further, the sample holder 3B comprises a first microfluidic channel 4 provided with a fluid inlet 41A and a fluid outlet 43A, here being connected to the microfluidic channel 4 via channels 57A, 55A for generating a sample fluid flow 59 of the fluid medium comprising through the holding space 5 (black arrow). Here, the fluid medium may comprise sample objects like cellular bodies 9. The sample holder 3B further comprises a first microfluidic channel 57B for generating a first sheath flow portion 61A (white arrow) in at least part of the first channel 4 and the holding space 5 adjacent the sample flow 59, and a second microfluidic channel 57C for generating a second sheath flow portion 61B in at least part of the first channel 4 and the holding space 5 adjacent the sample flow 59 opposite from the first sheath flow 61A (white arrow). The sheath flows may comprise and/or consist essentially of the sample liquid but without sample objects 9.

By controlling the absolute and relative flow strengths flux of each of the flows 59, 61A, 61B while maintaining all flows 59, 61A, 61B in the laminar flow regime as a whole and with respect to each other, the flows 59, 61A, 61B substantially do not mix in the channel 4 and the holding space 5. The control may comprise one or more of fluid pressure, fluid flow volume and flow velocity, possibly controlled using one or more controllable valves, sources, buffer reservoirs and/or pressurizers, etc. By flowing sheath fluids adjacent a sample fluid in the first channel in a laminar flow, the fluids will substantially remain unmixed and by adjustment of flow rates of the three flows with respect to each other (in particular the first and second sheath flows with respect to each other and with respect to the sample flow) a volume, position and direction of the sample flow through the first channel and/or the holding space can be controlled. The adjustment of the flow for any of the flows 59, 61A, 61B may range from no flow to fully filling up the channel 4 and/or holding space 5 with a single flow, effectively blocking the channel for further contributions of the other ones of the flows 59, 61A, 61B. Thus, the sample flow 59 may be controlled with respect to at least one of a size, location and/or a path of the sample flow 59 in at least part of the holding space 5. In such way an interaction position (or interaction region) in the holding space 5 may be selected, e.g. with respect to at least part of the functionalised wall surface 17 and/or a specific location of the acoustic force. During and/or after experiments this may also serve for flushing and/or collecting sample portions from specific locations of/from the holding 5.

From comparison of FIGS. 12 and 13 may be seen that one sample holder design may be used for both methods, also in combination, such as e.g. introduction of a sample portion as presented in (relation to) FIG. 13, and selection of different portions of objects 9 as presented in (relation to) FIG. 12 by suitably (re) connecting different sources and/or receptacles and reversing flow directions in at least part of the channels.

FIG. 14 shows a further sample holder 3C for microfluidic control, comprising both plural fluid outlets 43A-43C connected with the channel 4 and the holding space 5 via microfluidic sheath flow channels 55A-55B and plural fluid inlets 41A-41C connected with the channel 4 and the holding space 5 via microfluidic sheath flow channels 57A-57B. Thus, a first microfluidic sheath flow channel is provided with a first fluid inlet 41B and a first fluid outlet 43B and defining a first sheath flow path 41B-57B-4A-5-4B-55B-43B in the sample holder from the first inlet 41B to the first outlet 43B, and a second microfluidic sheath flow channel is provided with a second fluid inlet 410 and a first fluid outlet 430 and defining a second sheath flow path 410-57B-4A-5-4B-55C-43C in the sample holder 3C from the first inlet 41C to the first outlet 43C. Such sample holder 3C may be seen as a combination of the sample holders 3A and 3B of FIGS. 12 and 13. Thus, the sample flow and sheath flows 59, 61A-61B may be controlled more accurately. Also or alternatively, different sample portions may be flushed to selective ones of the outlets 43A-43C, Other designs of sample holders may be provided, e.g. comprising more, less and/or differently connected microfluidic sheath flow channels for generating sheath flows and/or for defining (sheath) flow paths.

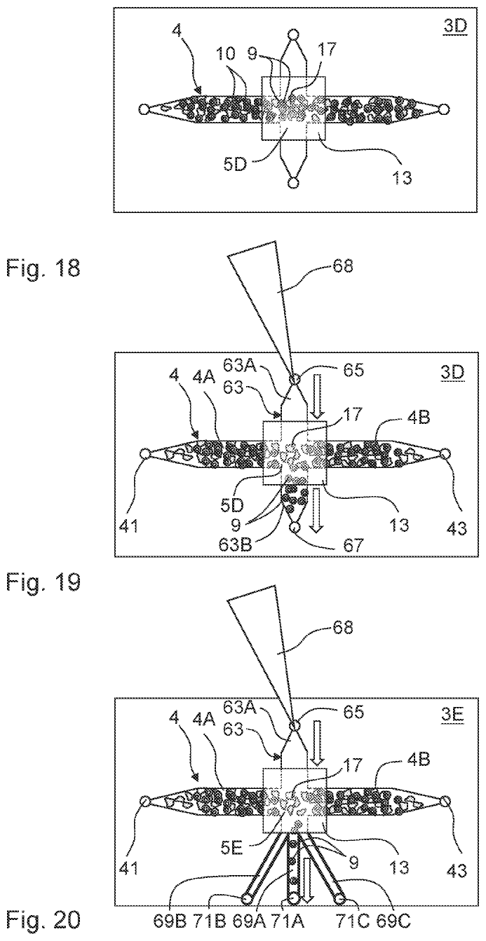

FIGS. 15-19 show a sample holder 3D reminiscent of the sample holders 3-3C. This sample holder 3D comprises a holding space 5D for holding a sample comprising one or more objects e.g. cellular bodies 9, 10, in a fluid medium, and an acoustic wave generator 13 to generate an acoustic wave in the holding space 50 exerting a force on at least part of the sample. The sample holder 3D comprises a first microfluidic channel 4 comprising channel portions 4A, 4B, being provided with a first fluid inlet 41 and a first fluid outlet 43 and defining a first flow path FP4 (41-4A-5D-4B-43) in the sample holder 3D from the first inlet 41 to the first outlet 43. The sample holder 3D further comprises a second microfluidic channel 63 comprising first and second channel portions 63A, 63B, and being provided with second fluid inlet 65 and a second fluid outlet 67 and defining a second flow path FP63 (65-63A-5D-63B-67) in the sample holder 3D from the second inlet 65 to the second outlet 67. The first and second flow paths FP4, FP63 extend perpendicular to each other and intersect each other in the holding space 5D, but note that other angles than perpendicular may also be provided.

FIGS. 15-19 indicate an exemplary method of manipulating and investigating objects in the sample holder 3D.

FIG. 15-16 indicate loading the holding space 5D with a sample fluid and target cells 10 via the inlet 41, cf. FIGS. 4-5. The target cells 10 are distributed via the first fluid path FP4 over the channel 4 and the holding space 50 and a functionalised wall surface portion 17 is formed.

FIGS. 17-18 indicate subsequent loading of a sample comprising effector cells 9 and/or other objects (not shown) in a sample fluid into the holding space 5D from a supply 49 via the first fluid path FP4 over the channel 4. The effector cells 9 and target cells 10 may be left to interact as discussed above. At a desired time an acoustic wave is generated in the holding space 5D by the acoustic wave generator 13, exerting a force on the cellular bodies 9 and/or other objects in at least part of the sample in the holding space 5D, with which at least some of the cellular objects 9 are suspended in the sample fluid and/or detached from the functionalised surface portion 17.

FIG. 19 shows providing a second fluid flow through the holding space 5D along a second flow path FP63 (indicated by the arrows). This may be done during and/or after generating the acoustic wave in the holding space 5D, and/or otherwise in dependence of at least one of the one or more parameter of the acoustic wave and/or in dependence to an observed parameter in the holding space. Since the second flow path FP63 only intersects the first flow path FB4 in the holding space 5D, the sample portion (in particular detached cells) flushed out of the holding space 5D are passed through second flow channel 63 without further interaction with cells in the second channel portion 4B of the first channel 4, and/or without being otherwise contaminated or affected by sample portions in that channel (portion). Thus, preparing of a sample and obtaining results from the sample may be largely decoupled.

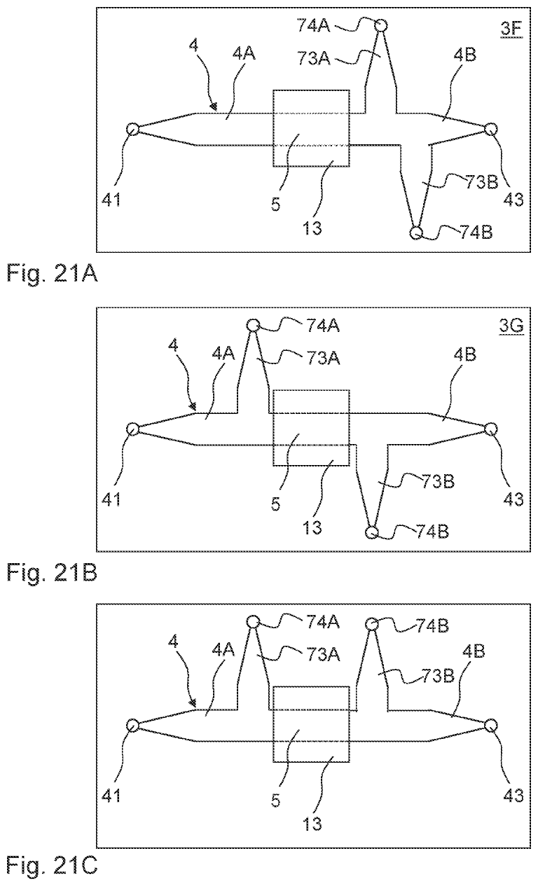

FIG. 20 shows an embodiment of a sample holder 3E comprising a holding space 5E and comprising plurality of microfluidic channels 69A-69C provided with an outlet 71A-71C. Each of the plurality of microfluidic channels 69A-69C defines a separate flow path in the sample holder 3E from the holding space 5E to the respective outlet 71A-71C, each starting from the inlet 65 such that each respective separate flow path 65-63A-5E-69A/69B/69C-71A/71B/71C at least partly intersects the first flow path FP4 in the holding space 5E. Thus, similar to FIG. 12, plural fluid outlets 71A-71C are directly accessible for fluid flows from the holding space 5E as exit ports for selecting and/or sorting sample portions. Also or alternatively, microfluidic channels 69A-69D and the outlets 71A-71C may be used for microfluidic sheath flows for controlling at least part of a sample flow and/or a sorting/selection flow from one or more particular portions of the holding space 5E. E.g., a fluid flow from a supply 68 may flush out detached cellular objects 9 to channel 69A and outlet 71A.

In yet another embodiment, not shown, the sample holder 3E of FIG. 20 may be used in reverse to the description of FIG. 20, such that the ports 71A-71C and channels 69A-69C are used as fluid inlets for introducing a fluid to the holding space 5E, possibly a sample fluid, cf. FIG. 12 relative to FIG. 13. In yet a further embodiment, not shown, the sample holder comprises a plurality of microfluidic channels provided with an outlet on one side of the first channel and holding space, as in FIG. 20, as well as a similar—not necessarily identical—set of microfluidic channels provided with an inlet on an opposite side of the first channel as just before described. In such embodiment, microfluidic flow control may be further improved, comparable to (the discussion of) FIG. 14 (or the discussion with respect to FIGS. 12-14 as a whole).

Also, combinations of embodiments of FIGS. 12-14 with FIGS. 15-19, FIG. or the embodiments described in the preceding paragraph could be provided and/or used.

FIG. 21A shows an embodiment, combinable with any other embodiment, of a sample holder 3F provided with an acoustic wave generator 13. The sample holder 3F comprises two microfluidic channels 73A, 73B each provided with an inlet or outlet 74A, 74B or, respectively, and being connected with the first channel 4 remote from the holding space 5 for providing a fluid flow in and/or through at least part of the first channel 4 offset from and not through the holding space 5. Thus, at least part of the first channel 4 may be flushed, e.g. by providing a fluid flow along a flow path 74A (and/or 74B)-73A (and/or 47B)-4B-43 and/or a flow path 74A-73A-4B-73B-74B and/or along such flow path in an opposite flow direction. This may also provide a way to provide nutrients and/or interaction moieties for either target cells 10 or cellular bodies 9 by diffusion from channel portion 4B to holding space 5 without disturbing the cells in the by any significant flow and/or shear stress.

Alternatively inlets and outlets may be placed on opposite sides of holding space 5 as shown for a sample holder 3G in FIG. 21B. Such embodiment facilitates a fluid flow along a flow path 74A-73A-4A-41 (or in opposite direction) and fluid flow along a flow path 74B 73B-4B-43 (or in opposite direction), possibly without net flow through the holding space 5. Clearly, a first flow path 41-4A-5-4B-43 (or in opposite direction) and a second flow path 74A-73A-4A-5-4B-73B-74B (or in opposite direction) cross and/or intersect in part of the channel 4 and in the holding space 5.

FIG. 21C shows an embodiment functionally substantially identical to sample holder 3G of FIG. 21B, wherein, compared to FIG. 21B, the flow paths channels 73A, 73B and inlets/outlets 74A, 74B arranged on the same side of the channel 4. Thus, a second flow path 74A-73A-4A-5-4B-73B-74B is generally U-shaped. Such embodiment could facilitate mounting and/or use in the system of FIG. 1 since connections to inlets/outlets 74A, 74B could be arranged on a common side. Channel 4 could also be provided with a U-shape and/or all connections could be arranged on a common side.

Placing the second flow path channels 73A, 73B outside of the holding space may serve to minimize impact of the side channels on the acoustic wave and/or associated distribution of acoustic forces.

Hg. 22 shows another embodiment of a sample holder 3H provided with an acoustic wave generator 13. The sample holder 3H comprises a holding space 5G for holding a sample comprising one or more objects in a fluid medium. The acoustic wave generator 13 is connected with the sample holder 3H to generate an acoustic wave in the holding space 5G exerting a force on at least part of the sample. The sample holder 3H comprises an inlet 41, a channel 4 having first and second channel portions 4A, 4B, and an outlet 43 for providing a sample comprising one or more objects to the holding space 5G as discussed in any embodiment before. The sample holder 3H comprises two interaction substance reservoirs 75 adjacent the holding space 5G. A plurality of diffusion channels 77 arranged on opposite sides of the holding space 5G connect each reservoir 75 to the holding space 5G separate from the first channel 4. Thus, any interaction substance, e.g. nutrients and/or interaction moieties for a sample containing biological matter, may be distributed along the holding space 5G so that undesired differences and/or gradients of the interaction substance in the holding space may be reduced or prevented. The number and/or distribution of the diffusion channels 77 and/or the shape and/or size of the reservoir may be provided with respect to one or more properties of the sample and/or the interaction substances. Also or alternatively, as in any embodiment, the acoustic wave generator 13 may be shaped and/or localised differently.

The diffusion channels 77 may be formed to filter substances between a reservoir 75 and the holding space 5G and/or to substantially decouple the reservoir 75 and the holding space 5G from flow and/or pressure differences in one of the reservoir 75 and the holding space 5G when manipulating (e.g. filling, changing, emptying, etc.) the other one of the reservoir 75 and the holding space 5G, and/or from effects of the acoustic wave, e.g. by providing at least part of the diffusion channels 77 with an appropriate size and/or pattern and/or other shape (e.g. bend).

In the embodiment shown in FIG. 22 the interaction reservoirs 75 are connected via channels 79 to an inlet 81 and via channels 83 to a common outlet 43. A common inlet assists providing a homogeneous distribution of the substance over the reservoirs 75 connected to the inlet with respect to one or more of composition, amount, pressure, flow velocity etc. However, one or more reservoirs 75 may be provided with independent inlets and/or outlets. Also or alternatively, one or more reservoirs 75 may be provided with one or more of separate channels and/or one or more separate inlets and/or outlets for independent control of a substance in the respective reservoir(s) 75.

Also or alternatively, the sample holder 3H may be used similar to the sample holder 3F of FIG. 21, i.e. the outlet 43 and a portion of the second channel portion 4B may be flushed by flushing a fluid via the inlet 81, channels 79 and 83 including the reservoirs 75 and outlet 43. Then objects and/or a sample fluid from a sample in the holding space 5G may be flushed to the outlet 43 in the same fashion as (described for) the embodiments of FIGS. 3-11 with little or no contamination of remaining substances in the outlet and possibly associated conduits. And also without disturbing the sample in the holding space. This may improve for example the ability to collect a batch of cells (e.g. a batch of cells which detached from a functionalized wall surface portion due to a specific detachment force) into a specific collection batch without contamination by a next batch of cells detaching at a higher acoustic force. i.e. if a batch of cells detaches inlet 41 can be temporarily opened and a small amount of flow in channel 4 and holding space 5G can be used to flush the batch of cells to the junction between channels 4B and 83. After this the inlet 41 can be closed and flow from inlet 81 can be used to flush the batch of cells from the junction all the way to the collection area where for example a splitter similar to splitter 51 in FIG. 11 can be used to send the batch to a specific collection sample. Then the flow from inlet 81 can be closed, the force can be increased and the next batch of cells can be gently flown to the junction after which this batch can be collected according to the same process.

Note that in this embodiment, as in any other embodiment, the words “inlet” and, respectively “outlet” are used primarily for ease of reference and may refer only to the sample holder in operation and with respect to a particular fluid flow direction, possibly governed by outside control systems, whereas the sample holder itself does not determine, define or suggest any particular in- and/or outflow direction. E.g., the connections 41, 43, 81 in the sample holder 3H may in practice be used as an inlet, as an outlet or as both as an inlet and an outlet subsequently, possibly within one experiment/experimental sequence; see also the discussions regarding FIGS. 12-13 and FIG. 20.

As discussed in relation to FIGS. 5 and 6 above, FIG. 23 indicates a cross section of part of a holding space of a sample holder as discussed herein comprising a first wall 15 and a second wall 16 defining a cavity 85 of the holding space. The (cavity 85 of the) holding space is being provided with a sample fluid 11 and a functionalised wall surface portion 17 on the basis of cellular bodies 10, cf. FIG. 2A.

FIG. 24 indicates the cross section of the sample holder of Hg. 23 subject to a sample fluid flow SFF of the fluid 11. In response to the sample fluid flow SFF the is cells 10 have taken up a more globular shape interrupting the functionalised wall surface portion 17.

The disclosure is not restricted to the above described embodiments which can be varied in a number of ways within the scope of the claims.

Various embodiments of methods and/or method steps may be implemented as a program product for use with a computer system, where the program(s) of the program product define functions of the embodiments (including the methods described herein). E.g., controlling operation of one or more of the acoustic wave generator, one or more valves, one or more pumps, temperature control devices, cameras, etc. In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored.

Elements and aspects discussed for or in relation with a particular embodiment may be suitably combined with elements and aspects of other embodiments, unless explicitly stated otherwise.

1. A method of manipulating and/or investigating objects, comprising:
providing a sample holder comprising a holding space for holding a fluid medium;
providing a sample comprising one or more objects in a fluid medium in the holding space;
generating an acoustic wave in the holding space exerting a force on the one or more objects of the sample in the holding space;
providing a sample fluid flow through the holding space; and
providing a sheath flow adjacent the sample fluid flow and controlling, using the sheath flow, at least one of a size, location and/or a path of the sample flow in at least part of the holding space.

2. The method according to claim 1, comprising:
wherein providing a sample comprising one or more objects in a fluid medium in the holding space comprises providing the sample into the holding space along a first flow path in the sample holder, and
wherein the method further comprises providing one or more second fluid flows in the sample holder along a second flow path, and in case of more second fluid flows each along a different respective second flow path, wherein at least part of the one or more second flow paths and the first flow path pass through a common channel and/or the holding space.

3. The method according to claim 2, comprising providing one or more second fluid flows through the holding space.

4. The method according to claim 2, wherein one or more parameters of the acoustic wave are adjustable, the one or more parameters of the acoustic wave being selected from application, power, amplitude, wavelength, frequency and variations thereof, and
wherein the method comprises providing the second fluid flow or at least one of the one or more second fluid flows, respectively, in dependence of at least one of the one or more parameters of the acoustic wave.

5. The method according to claim 1, comprising:
wherein providing a sample comprising one or more objects in a fluid medium in the holding space comprises providing the sample into the holding space along a first flow path in the sample holder through a first channel, and
wherein the method further comprises providing an interaction substance source in a reservoir in the sample holder, establishing a fluid contact between the source and the sample space and providing at least some of the interaction substance to the objects by diffusion via a diffusion channel between the reservoir and the holding space.

6. The method according to claim 1, wherein in particular the one or more objects comprise biological objects;
wherein the method further comprises providing the holding space with a functionalised wall surface portion to be contacted by the sample and
wherein the sample is in contact with the functionalised wall surface portion during at least part of the step of generating the acoustic wave.

7. The method according to claim 1, comprising detecting one or more signals indicative of adhesion and/or detachment of at least one of the one or more objects to/from at least part of the sample holder.

8. The method according to claim 7, comprising detecting the one or more signals indicative of adhesion and/or detachment of at least one of the one or more objects to/from at least part of the sample holder as a function of at least one parameter of the acoustic wave selected from duration of application, power, amplitude and frequency.

9. The methods according to claim 7, comprising separating at least one object from the one or more objects, based on at least one parameter of the acoustic wave.

10. A system for manipulating and/or investigating objects, comprising
a sample holder comprising a holding space for holding a sample comprising one or more objects in a fluid medium, and
an acoustic wave generator connected with the sample holder to generate an acoustic wave in the holding space exerting a force on at least part of the sample,
wherein the sample holder comprises a first microfluidic sample channel provided with a fluid inlet and a fluid outlet for generating a sample fluid flow of the fluid medium through the holding space and
a first microfluidic channel portion for generating a first sheath flow portion in at least part of the first channel and the holding space adjacent the sample flow, and
a second microfluidic channel portion for generating a second sheath flow portion in at least part of the first channel and the holding space adjacent the sample flow opposite from the first sheath flow.

11. The system according to claim 10, comprising
wherein the sample holder comprises
a first microfluidic channel provided with a first fluid inlet and a first fluid outlet and defining a first flow path in the sample holder from the first inlet to the first outlet, and
a second microfluidic channel comprising a second fluid inlet and a second fluid outlet and defining a second flow path in the sample holder from the second inlet to the second outlet,
such that at least part of the first and second flow paths pass through a common channel and/or the holding space.

12. The system according to claim 11, wherein the sample holder comprises a plurality of microfluidic channels provided with an inlet and/or an outlet, each of the plurality of microfluidic channels defining at least part of a flow path in the sample holder from a respective inlet to a respective outlet, such that each respective separate flow path crosses and/or intersects the first flow path.

13. The system according to claim 11, wherein the sample holder comprises a plurality of microfluidic channels provided with an inlet and/or an outlet, each of the plurality of microfluidic channels defining at least part of a separate flow path in the sample holder from the respective inlet to the holding space and/or from the holding space to the respective outlet, such that each respective separate flow path crosses and/or intersects the first flow path in the holding space.

14. The system according to claim 10, wherein the system comprises a controller connected with the acoustic wave generator and being configured to control one or more parameters of the acoustic wave, and
wherein the system comprises a fluid flow controller connected to the inlets and outlets of the sample holder and being configured for providing a fluid flow along each of the respective flow paths.

15. The system according to claim 10, the system comprising
wherein the sample holder comprises at least one nutrient and/or interaction substance reservoir,
at least one a diffusion channel connecting the reservoir to the holding space separate from the first channel.

16. The system according to claim 10, the system comprising
wherein the sample holder comprises a first microfluidic channel provided with a fluid inlet and a fluid outlet for generating a sample fluid flow of the fluid medium through the holding space and
wherein the sample holder comprises one or more microfluidic channels provided with at least one of an inlet and an outlet and being connected with the first channel remote from the holding space for providing a fluid flow in and/or through at least part of the first channel offset from and not through the holding space.

17. A method of manipulating and/or investigating objects, comprising:
providing a sample holder comprising a holding space for holding a fluid medium;
providing a sample comprising one or more objects in a fluid medium in the holding space;
generating an acoustic wave in the holding space exerting a force on the one or more objects of the sample in the holding space;
wherein providing a sample comprising one or more objects in a fluid medium in the holding space comprises providing the sample into the holding space along a first flow path in the sample holder, and
providing one or more second fluid flows in the sample holder along a second flow path, and in case of more second fluid flows each along a different respective second flow path, wherein at least part of the one or more second flow paths and the first flow path pass through a common channel and/or the holding space.

18. The method according to claim 17, comprising providing plural second fluid flows through the holding space, each along a different respective second flow path, wherein each of the respective different second flow paths pass through the holding space, in particular crossing and/or intersecting the first flow path in the holding space.

19. The method according to claim 17, wherein one or more parameters of the acoustic wave are adjustable, the one or more parameters of the acoustic wave being selected from application, power, amplitude, wavelength, frequency and variations thereof, and
wherein the method comprises providing the second fluid flow or at least one of the one or more second fluid flows, respectively, in dependence of at least one of the one or more parameters of the acoustic wave.
